(19) United States
(12) Patent Application Publication
(10) Pub. No.: US 2026/0344651 A1
(43) Pub. Date: Nov. 5, 2026

(54) PANEL BARRIER ASSEMBLY AND SYSTEM THEREOF

(71) Applicant: Mid-West Metal Products Company, Inc., Muncie, IN (US)

(72) Inventors: Stew Kerr, Muncie, IN (US); Michael Eric Greene, Muncie, IN (US); Brad Cantwell, Muncie, IN (US); Scott Alan Henry, Albany, IN (US)

(21) Appl. No.: 19/666,930

(22) Filed: May 4, 2026

Related U.S. Application Data
(60) Provisional application No. 63/799,973, filed on May 5, 2025.

(51) Int. Cl. A01M 29/30

(52) U.S. Cl. CPC A01M 29/30

(57) ABSTRACT

A panel barrier assembly used for at least partially obstructing an opening includes a first panel configured to be disposed within a first plane. The first panel includes at least a first wire, a second wire, a third wire, and a plurality of ground wires. A second panel configured to be disposed within a second plane includes a plurality of interconnecting wires including a plurality of horizontal wires and a plurality of transverse wires. The plurality of ground wires is oriented in a direction generally perpendicular to the first wire, second wire, and third wire, and at least one of the plurality of ground wires is removably coupled to one of the plurality of transverse wires. The first plane is generally angled relative to the second plane.

### RELATED APPLICATIONS

This application claims the benefit of U.S. Provisional Patent Application Ser. No. 63/799,973, filed May 5, 2025, the disclosure of which is hereby incorporated by reference in its entirety.

### FIELD OF THE DISCLOSURE

The present disclosure relates to a panel barrier assembly, and in particular to a panel barrier assembly configured to protect an underlying surface such as grass.

### BACKGROUND

Conventional barriers are used to inhibit the passage of animals through a defined area. Conventional barriers often need to be reinforced for a variety of reasons, such as to fill gaps under and between components, to reinforce compromised components, or to prevent animals from passing through, under, or around the barrier. Conventional barriers often are unable to prevent passage of animals through spaces and are not easily usable, maintained, and installed.

Thus, there is a need for a barrier assembly capable of obstructing a defined gap or space.

### SUMMARY

In a first implementation of the present disclosure, a panel barrier assembly used for at least partially obstructing an opening includes a first panel configured to be disposed within a first plane. The first panel includes at least a first wire, a second wire, a third wire, and a plurality of ground wires. A second panel configured to be disposed within a second plane includes a plurality of interconnecting wires including a plurality of horizontal wires and a plurality of transverse wires. The plurality of ground wires is oriented in a direction generally perpendicular to the first wire, second wire, and third wire, and at least one of the plurality of ground wires is removably coupled to one of the plurality of transverse wires. The first plane is generally angled relative to the second plane.

In one example of the first implementation, the first and second wires are offset from the third wire. In a second example, the first and second wires are offset from one another in a third plane, the third plane being generally perpendicular to the first plane. In a third example, the first wire and second wire define a gap therebetween. In a fourth example, each of the plurality of ground wires is located within the gap. In a fifth example, the plurality of ground wires is coupled to the first wire or second wire at coupling locations within the gap.

In a sixth example, each of the plurality of ground wires have a first portion located within the gap and a second portion located outside of the gap and configured to be disposed within an underlying ground surface. In a seventh example, at least one of the plurality of transverse wires forms an eyelet configured to receive a third portion of the ground wires, the third portion located between the first portion and the second portion. In an eighth example, at least two of the plurality of transverse wires forms an eyelet. In a ninth example, the third wire includes a plurality of third wires, the plurality of third wires offset from one another and the first and second wires in the first plane.

In a tenth example, the plurality of ground wires is equidistantly offset from one another within the first plane. In an eleventh example, at least one ground wire of the plurality of ground wires is slidably coupled to one of the transverse wires of the plurality of transverse wires. In a twelfth example, a stake is provided having at least one end and a receiving portion, the at least one end configured to penetrate into the underlying ground surface and the receiving portion configured to receive one of the plurality of transverse wires.

In another implementation of the present disclosure, an assembly of panel barrier assemblies for obstructing an opening include a first panel barrier assembly and a second panel barrier assembly. The first panel barrier assembly includes a first panel configured to be disposed within a first plane, the first panel having at least a first wire, a second wire, a third wire, and a plurality of ground wires; and a second panel configured to be disposed within a second plane, the second panel including a plurality of interconnecting wires including a plurality of horizontal wires and a plurality of transverse wires; wherein, at least one of the plurality of ground wires is removably coupled to one of the plurality of transverse wires. The second panel barrier assembly includes a first panel configured to be disposed within a first plane, the first panel having at least a first wire, a second wire, a third wire, and a plurality of ground wires; and a second panel configured to be disposed within a second plane, the second panel including a plurality of interconnecting wires including a plurality of horizontal wires and a plurality of transverse wires; wherein, at least one of the plurality of ground wires is removably coupled to one of the plurality of transverse wires; wherein, the first panel barrier assembly is positioned adjacent to the second panel barrier assembly such that the first panel of the first barrier assembly is disposed at an angle relative to the first panel of the second barrier assembly.

In one example of the implementation, the first panel barrier assembly is removably coupled to the second panel barrier assembly. In another example, the first plane of the first panel barrier assembly is coplanar with the first plane of the second panel barrier assembly, and the second plane of the first panel barrier assembly is coplanar with the second plane of the second panel barrier assembly.

In a further implementation of the present disclosure, a method for assembling a panel barrier assembly to obstruct an opening in a fence includes positioning a second panel of the panel barrier assembly on an underlying ground surface adjacent to the opening in the fence, the second panel including a plurality of interconnecting wires including a plurality of horizontal wires and a plurality of transverse wires; positioning a first panel of the panel barrier assembly relative to the second panel, the first panel including a first wire, a second wire, a third wire, and a plurality of ground wires; aligning at least one of the plurality of ground wires with an eyelet formed by one of the plurality of transverse wires; disposing the at least one of the plurality of ground wires into the eyelet to couple the first panel to the second panel; and pushing the first panel to penetrate into the underlying ground surface at a depth such that the first panel is configured to obstruct the opening in the fence.

In one example of this implementation, the first panel is slidably coupled to the second panel. In a second example, the method includes arranging the first panel in an upright position and at an angle relative to the second panel. In another example, the method includes pressing at least one stake into the underlying surface; and coupling the at least one stake to the second panel by locating one of the plurality of horizontal wires or one of the plurality of transverse wires within a receiving portion of the at least one stake.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is one example implementation of a perspective view of a panel barrier assembly;

FIG. 2 is another example implementation of the panel barrier assembly of FIG. 1; and

FIG. 3 is another example implementation of a plurality of panel barrier assemblies of FIGS. 1 and 2.

Corresponding reference numerals are used to indicate corresponding parts throughout the several views.

### DETAILED DESCRIPTION

The implementations of the present disclosure described below are not intended to be exhaustive or to limit the disclosure to the precise forms disclosed in the following detailed description. Rather, the implementations are chosen and described so that others skilled in the art may appreciate and understand the principles and practices of the present disclosure.

The present disclosure relates to a barrier configured to obstruct or at least partially block an opening, gap or space. For example, the barrier may be configured to be positioned along a fence wherein the barrier may obstruct or partially block an opening in or underneath the fence. For instance, the barrier may block an opening between the fence and the underlying ground.

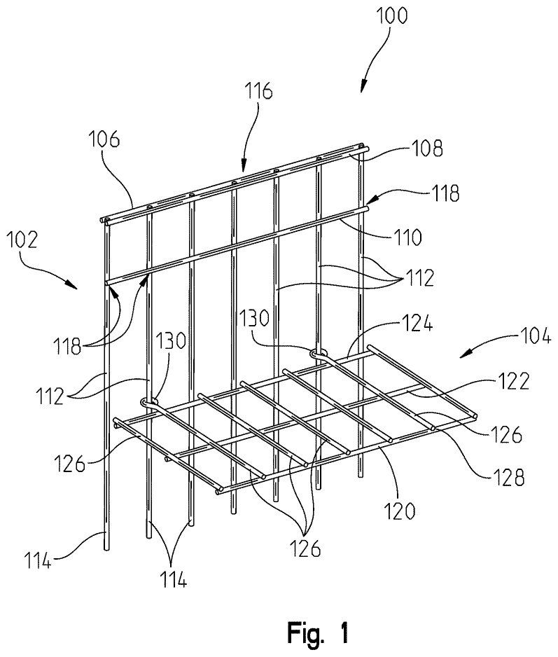

Referring to FIG. 1, one implementation of a panel barrier assembly 100 is shown. The panel barrier assembly 100 is unlike most conventional barriers in that it includes a first panel 102 and a second panel 104. The first panel 102 may be oriented within a first plane, and the second panel 104 may be oriented in a second plane. In some implementations, the first plane and second plane may be perpendicular to one another. In several implementations, the first plane and second plane may be angled relative to one another.

In one implementation, the first panel 102 may be formed by a plurality of interconnecting wires. The interconnecting wires may include at least a first wire 106, a second wire 108 and a third wire 110. The interconnecting wires may also include a plurality of ground wires 112. As shown in FIG. 1, the plurality of ground wires 112 may be approximately perpendicularly oriented relative to the first wire 106, second wire 108, and third wire 110. The plurality of ground wires 112 may be spaced from one another. In some implementations, each of the plurality of ground wires 112 may be equidistantly spaced from one another. In other implementations, each of the plurality of ground wires 112 may not be spaced equidistantly from one another. In one implementation, there may be at least five (5) ground wires 112 spaced from one another. In another implementation, there may be at least three (3) ground wires 112 spaced from one another. In yet another implementation, there may be at least ten (10) wires spaced from another. In some implementations, the number of plurality of ground wires 112 may define a width of the panel barrier assembly 100.

The first wire 106, second wire 108 and third wire 110 may be coupled to the plurality of ground wires 112 at one or more locations. As shown in FIG. 1, the wires may be coupled at one or more coupling locations 118. In one implementation, each coupling location 118 may include a weld coupling. In another implementation, each coupling location 118 may include an adhesive coupling. In yet another implementation, each coupling location 118 may include a fastener or other mechanical coupling. Other types of coupling the first wire 106, second wire 108 and third wire 110 to the plurality of ground wires 112 are contemplated by this disclosure.

In the implementation of FIG. 1, the first wire 106 and second wire 108 are located adjacent but offset from one another. As shown, a gap 116 may be formed between the first wire 106 and second wire 108. The gap 116 may be any size. In one implementation, the gap 116 is proximately the same size as a diameter of one of the plurality of ground wires 112. In some implementations, the first wire 106 and second wire 108 may be coupled to each of the plurality of ground wires 112 at coupling locations 118 located within the gap 116. In other implementations, the plurality of ground wires 112 may be coupled to only one of the first wire 106 or second wire 108 in the gap 116. In yet another implementation, the plurality of ground wires 112 may not be coupled to either the first wire 106 or second wire 108 in the gap or elsewhere.

The third wire 110 may be disposed offset in the first plane from the first wire 106 and second wire 108. In FIG. 1, the third wire 110 may be coupled to each of the plurality of ground wires 112. In one implementation, the third wire 110 may be welded to each of the plurality of ground wires 112. In another implementation, the third wire 110 may be adhered to each of the plurality of ground wires 112. In a further implementation, the third wire 110 may be mechanically coupled via a fastener to each of the plurality of ground wires 112.

In some implementations, the third wire 110 may be coupled to the plurality of ground wires 112 at locations near the gap 116 when the first wire 106 and/or second wire 108 is not coupled to one or more of the ground wires 112. In other implementations, the third wire 110 may be coupled to the plurality of ground wires 112 at locations further offset from the gap 116 when the first wire 106 and/or second wire 108 is coupled to one or more of the plurality of ground wires 112.

As shown in FIG. 1, the plurality of ground wires 112 may include a first end or portion 114 and an opposite end or portion. The opposite end or portion of each of the plurality of ground wires 112 may be disposed within the gap 116 formed by the first wire 106 and second wire 108. In one implementation, the opposite end or portion of each of the plurality of ground wires 112 may be coupled within the gap 116 to the first wire 106 and second wire 108 at corresponding coupling locations 118. In another implementation, the opposite end or portion of each of the plurality of ground wires 112 may be welded within the gap 116 to the first wire 106 and second wire 108 at corresponding coupling locations 118. In yet another implementation, the opposite end or portion of each of the plurality of ground wires 112 may be adhered within the gap 116 to the first wire 106 and second wire 108 at corresponding coupling locations 118. In a further implementation, the opposite end or portion of each of the plurality of ground wires 112 may be mechanically coupled via a fastener to the first wire 106 and second wire 108 at corresponding coupling locations 118.

In some implementations, the first end or portion 114 of each of the plurality of ground wires 112 may include a sharpened or pointed end. In several implementations, the first end or portion 114 of each of the plurality of ground wires 112 may include a conically shaped end. In yet other implementations, the first end or portion 114 of each of the plurality of ground wires 112 may include a blunted end. In any event, the first end or portion 114 of each of the plurality of ground wires 112 may be shaped to facilitate penetration into the underlying ground similar to a stake. In this manner, the first panel 102 may be maintained in an upright position relative to the underlying ground as the first end or portion 114 of each of the plurality of ground wires 112 is disposed within the underlying ground.

While one implementation of the first panel 102 is shown in FIG. 1 and described herein, it is to be understood in other implementations the first panel 102 may include fewer wires or additional wires. The size and shape of the first panel 102 may also depend on the size and shape of the opening, gap or space being covered by the first panel 102. As the first panel 102 is the portion of the assembly 100 that at least partially covers or obstructs the opening, gap or space, the first panel 102 may be designed or configured based on the size and shape of the opening, gap or space. For example, in some implementations, the height of the opening, gap or space may be such that additional third wires 108 may be coupled to the plurality of ground wires 112 and vertically offset from one another within the first plane so that the first panel 102 can have an increased height.

The second panel 104 may also include a plurality of interconnected wires. As shown in the implementation of FIG. 1, the second panel 104 may include a first horizontal wire 120, a second horizontal wire 122, and a third horizontal wire 124. In other implementations, the second panel 104 may include fewer or additional horizontal wires. Thus, the example implementation of FIG. 1 is only example of many contemplated by this disclosure.

The second panel 104 may also include one or more transverse wires 126. The one or more transverse wires 126 may be coupled to the first horizontal wire 120, second horizontal wire 122, and third horizontal wire 124. In one implementation, the one or more transverse wires 126 may be welded to the first horizontal wire 120, second horizontal wire 122, and third horizontal wire 124. In another implementation, the one or more transverse wires 126 may be adhered to the first horizontal wire 120, second horizontal wire 122, and third horizontal wire 124. In a further implementation, the one or more transverse wires 126 may be mechanically coupled via a fastener to the first horizontal wire 120, second horizontal wire 122, and third horizontal wire 124. Other implementations for coupling the one or more transverse wires 126 to the first, second, and third horizontal wires may be possible.

As shown in FIG. 1, at least one of the one or more transverse wires 126 includes a first end or portion 128 and an opposite end or portion forming an eyelet portion 130. As shown, the eyelet portion 130 of the at least one of the one or more transverse wires 126 is configured to receive one of the plurality of ground wires 112 of the first panel 102. In this way, the first panel 102 and second panel 104 are removably coupled to one another when one of the plurality of ground wires 112 is inserted into the eyelet portion 130. In some implementations, the ground wire 112 is slidably coupled within the eyelet portion 130 to accommodate the coupling of the first panel 102 and second panel 104 to one another. In this manner, the first panel 102 can be adjusted relative to the second panel 104 to achieve a desired height. For example, if the opening or gap has a certain height, the amount or depth to which the plurality of ground wires 112 are pushed into the underlying ground surface may be adjusted based on the height. This is possible due to the manner in which the first panel 102 and second panel 104 are coupled to one another.

In another implementation, the ground wire 112 may be welded or fixedly coupled to one.

In the implementation of FIG. 1, the second panel 104 is configured to be placed or positioned on the underlying ground surface. In other words, the second plane in which the second panel 104 is disposed lies parallel to a plane defined along the ground or underlying ground surface.

With the first panel 102 being coupled to the second panel 104 as shown in FIG. 1, an animal is unable to dig or dislodge the first panel 102 due to the presence of the second panel 104. Thus, the second panel 104 provides support as well as protection to the first panel 102.

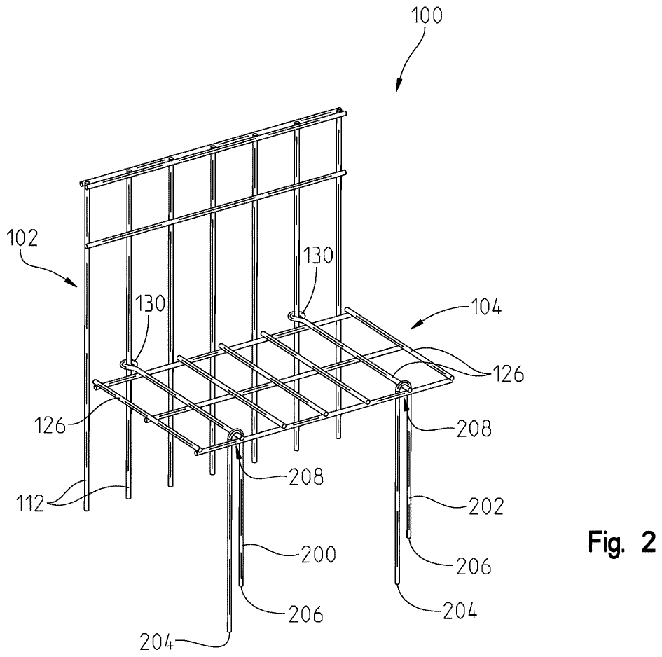

Referring to FIG. 2, another implementation of the panel barrier assembly 100 is shown. In this implementation, a first stake 200 and a second stake 202 are shown. The first and second stakes may include a first stake end 204 and a second stake end 206. The first and second stakes may be formed as a single wire in some implementations. In other implementations, more than a single wire may be coupled to form the first and second stakes.

As shown in FIG. 2, the first stake 200 and second stake 202 are formed to include an open end and a closed end. The open end is formed by the first stake end 204 and second stake end 206. At the closed end, a receiving portion 208 is formed by the first stake 204 and second stake 206. In the illustrated implementation of FIG. 2, the first stake 200 is positioned within the ground and arranged such that one of the plurality of transverse wires 126 is disposed within the receiving portion 208 of the first stake 200. The first stake end 204 and the second stake end 206 may include a sharpened or pointed edge for helping with penetrating through the soil in the ground or underlying ground surface. Thus, the first stake 200 may be pushed into the ground or underlying ground surface until the receiving portion 208 thereof is in contact or in close proximity with the one of the plurality of transverse wires 126. As a result, the first stake 200 may hold or maintain the second panel 104 in proximate alignment with the ground or underlying ground surface.

The second stake 202 may be shaped and positioned in a similar manner as the first stake 200 for holding or maintaining the second panel 104 in proximate alignment with the ground or underlying ground surface.

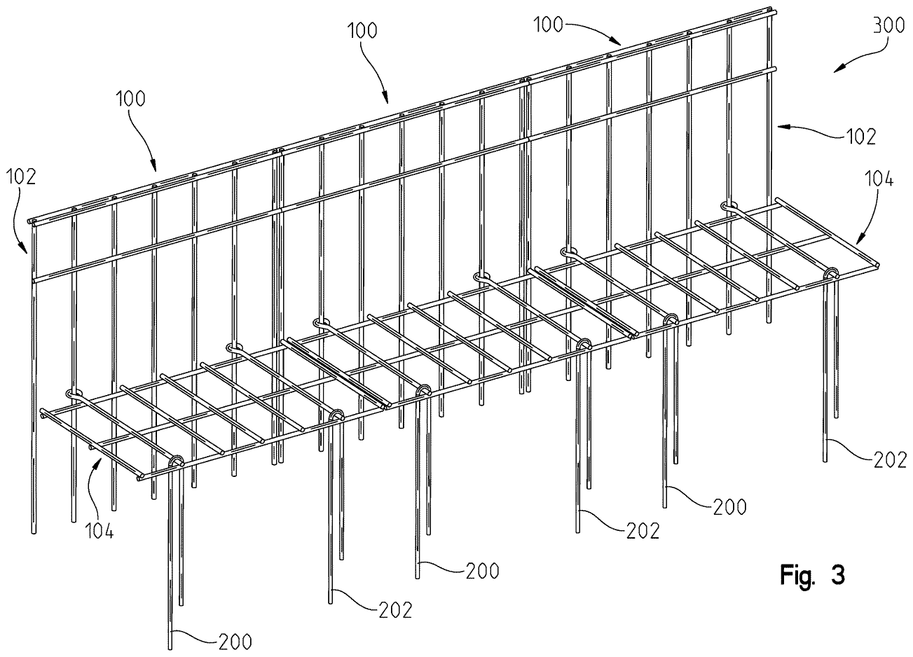

Referring to the implementation illustrated in FIG. 3, an alignment 300 of a plurality of barrier panel assemblies 100 is shown. In some implementations, the alignment 300 of the plurality of barrier panel assemblies 100 may be disposed along a ground or underlying ground surface adjacent to a fence, for example. In this implementation, two or more barrier panel assemblies 100 may be aligned adjacent to one another as shown. In some implementations, the two or more barrier panel assemblies 100 may be removably coupled to one another. In other implementations, the two or more barrier panel assemblies 100 are not coupled to one another. For example, a latch, fastener or other mechanical device may be used for coupling two barrier panel assemblies 100 to one another.

In some arrangements, a first barrier panel assembly 100 may be positioned in alignment with a second barrier panel assembly 100. For example, in one implementation, the first panel 102 of the first barrier panel assembly 100 may be aligned at least partially parallel with the first panel 102 of the second barrier panel assembly 100. In another implementation, the first panel 102 of the first barrier panel assembly 100 may be aligned at least partially coplanar with the first panel 102 of the second barrier panel assembly 100. In a further implementation, the first panel 102 of the first barrier panel assembly 100 may be aligned at an angle with respect to the first panel 102 of the second barrier panel assembly 100. In yet a further implementation, the first panel 102 of the first barrier panel assembly 100 may be aligned perpendicularly with the first panel 102 of the second barrier panel assembly 100.

In at least one implementation, a kit may include fasteners and the like for achieving the coupling between the different panels and barrier panel assemblies. For example, a kit may include a plurality of first panels 102, a plurality of second panels 104, and a plurality of stakes 200, 202. In other kits, a plurality of fasteners may be provided for coupling two or more barrier panel assemblies 100 to one another.

While exemplary implementations incorporating the principles of the present disclosure have been disclosed hereinabove, the present disclosure is not limited to the disclosed implementations. Instead, this application is intended to cover any variations, uses, or adaptations of the present disclosure using its general principles. Further, this application is intended to cover such departures from the present disclosure as come within known or customary practice in the art to which this disclosure pertains and which fall within the limits of the appended claims.

1. A panel barrier assembly for at least partially obstructing an opening, comprising:
a first panel configured to be disposed within a first plane, the first panel comprising at least a first wire, a second wire, a third wire, and a plurality of ground wires; and
a second panel configured to be disposed within a second plane, the second panel comprising a plurality of interconnecting wires including a plurality of horizontal wires and a plurality of transverse wires;
wherein, the plurality of ground wires is oriented in a direction generally perpendicular to the first wire, second wire, and third wire;
wherein, at least one of the plurality of ground wires is removably coupled to one of the plurality of transverse wires;
wherein, the first plane is generally angled relative to the second plane.

2. The panel barrier assembly of claim 1, wherein the first and second wires are offset from the third wire.

3. The panel barrier assembly of claim 1, wherein the first and second wires are offset from one another in a third plane, the third plane being generally perpendicular to the first plane.

4. The panel barrier assembly of claim 1, wherein the first wire and second wire define a gap therebetween.

5. The panel barrier assembly of claim 4, wherein each of the plurality of ground wires is located within the gap.

6. The panel barrier assembly of claim 5, wherein the plurality of ground wires is coupled to the first wire or second wire at coupling locations within the gap.

7. The panel barrier assembly of claim 4, wherein each of the plurality of ground wires have a first portion located within the gap and a second portion located outside of the gap and configured to be disposed within an underlying ground surface.

8. The panel barrier assembly of claim 1, wherein at least one of the plurality of transverse wires forms an eyelet configured to receive a third portion of the ground wires, the third portion located between the first portion and the second portion.

9. The panel barrier assembly of claim 8, wherein at least two of the plurality of transverse wires forms an eyelet.

10. The panel barrier assembly of claim 1, wherein the third wire comprises a plurality of third wires, the plurality of third wires offset from one another and the first and second wires in the first plane.

11. The panel barrier assembly of claim 1, wherein the plurality of ground wires is equidistantly offset from one another within the first plane.

12. The panel barrier assembly of claim 1, wherein at least one ground wire of the plurality of ground wires is slidably coupled to one of the transverse wires of the plurality of transverse wires.

13. The panel barrier assembly of claim 1, further comprising a stake having at least one end and a receiving portion, the at least one end configured to penetrate into the underlying ground surface and the receiving portion configured to receive one of the plurality of transverse wires.

14. An assembly of panel barrier assemblies for obstructing an opening, comprising:
a first panel barrier assembly comprising:
a first panel configured to be disposed within a first plane, the first panel comprising at least a first wire, a second wire, a third wire, and a plurality of ground wires; and
a second panel configured to be disposed within a second plane, the second panel comprising a plurality of interconnecting wires including a plurality of horizontal wires and a plurality of transverse wires;
wherein, at least one of the plurality of ground wires is removably coupled to one of the plurality of transverse wires; and
a second panel barrier assembly comprising:
a first panel configured to be disposed within a first plane, the first panel comprising at least a first wire, a second wire, a third wire, and a plurality of ground wires; and
a second panel configured to be disposed within a second plane, the second panel comprising a plurality of interconnecting wires including a plurality of horizontal wires and a plurality of transverse wires;
wherein, at least one of the plurality of ground wires is removably coupled to one of the plurality of transverse wires;
wherein, the first panel barrier assembly is positioned adjacent to the second panel barrier assembly such that the first panel of the first barrier assembly is disposed at an angle relative to the first panel of the second barrier assembly.

15. The assembly of claim 14, wherein the first panel barrier assembly is removably coupled to the second panel barrier assembly.

16. The assembly of claim 14, wherein the first plane of the first panel barrier assembly is coplanar with the first plane of the second panel barrier assembly, and the second plane of the first panel barrier assembly is coplanar with the second plane of the second panel barrier assembly.

17. A method for assembling a panel barrier assembly to obstruct an opening in a fence, the method comprising:
positioning a second panel of the panel barrier assembly on an underlying ground surface adjacent to the opening in the fence, the second panel comprising a plurality of interconnecting wires including a plurality of horizontal wires and a plurality of transverse wires;
positioning a first panel of the panel barrier assembly relative to the second panel, the first panel comprising a first wire, a second wire, a third wire, and a plurality of ground wires;
aligning at least one of the plurality of ground wires with an eyelet formed by one of the plurality of transverse wires;
disposing the at least one of the plurality of ground wires into the eyelet to couple the first panel to the second panel; and
pushing the first panel to penetrate into the underlying ground surface at a depth such that the first panel is configured to obstruct the opening in the fence.

18. The method of claim 17, wherein the first panel is slidably coupled to the second panel.

19. The method of claim 17, further comprising arranging the first panel in an upright position and at an angle relative to the second panel.

20. The method of claim 17, further comprising:
pressing at least one stake into the underlying surface; and
coupling the at least one stake to the second panel by locating one of the plurality of horizontal wires or one of the plurality of transverse wires within a receiving portion of the at least one stake.
